(19) United States
(12) Patent Application Publication
(10) Pub. No.: US 2016/0125329 A1
(43) Pub. Date: May 5, 2016

(54) SYSTEM AND METHOD FOR CONFIGURATION-MANAGED LIFECYCLE DIAGRAMS

(71) Applicant: Siemens Product Lifecycle Management Software Inc., Plano, TX (US)

(72) Inventors: Narinder Nayar, Troy, MI (US); Raymond Kok, East Windsor, NJ (US); Kenneth Sears, Docking (GB)

(21) Appl. No.: 14/528,057

(22) Filed: Oct. 30, 2014

(51) Int. Cl. G06Q 10/06

(52) U.S. Cl. CPC G06Q 10/067

(57) ABSTRACT

Methods for product data management and corresponding systems and computer-readable mediums. A method includes executing an application. The method includes receiving a diagram having layout data, configuration conditions, and a plurality of business objects. The method includes populating the diagram according to the layout data, the configuration conditions, and the business objects. The method includes displaying the configured diagram.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include methods for product data management and corresponding systems and computer-readable mediums. A method includes executing an application. The method includes receiving a diagram having layout data, configuration conditions, and a plurality of business objects represented by symbols on the diagram. The method includes populating the diagram according to the layout data, the configuration conditions, and the business objects. The method includes displaying the configured diagram.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates elements of a system as disclosed herein, as are stored and managed by a data processing system in accordance with disclosed embodiments;

FIGS. 3A and 3B illustrate a data processing system processing business objects and layout data according to configuration conditions to produce a configured diagram in accordance with disclosed embodiments; and

FIG. 4 illustrates a flowchart of a process in accordance with disclosed embodiments.

### DETAILED DESCRIPTION

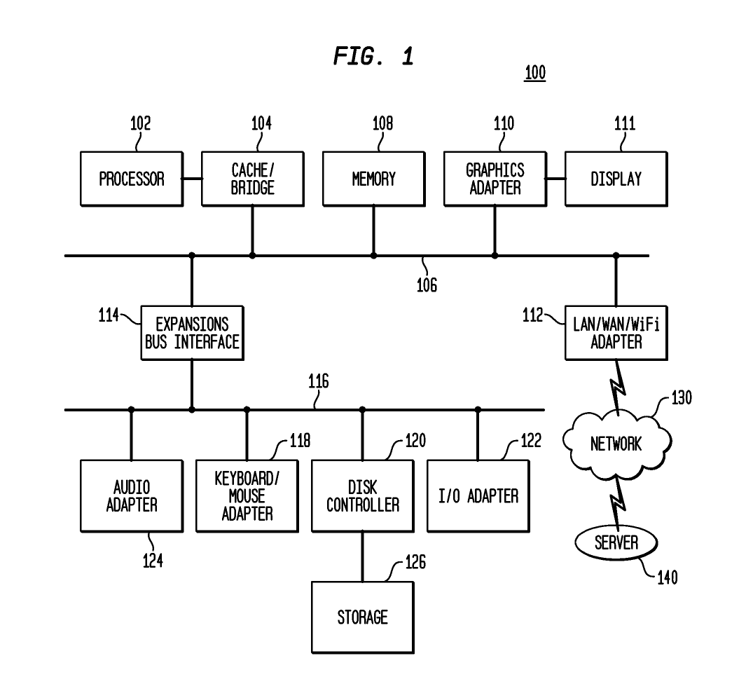

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include systems and methods for configuring and managing diagram layouts. According to disclosed embodiments, the layout is loosely coupled to the business objects that are modeled on the diagram. The user authors the business objects with a configuration condition that also assigns the configuration condition to the layout data. Various embodiments include one or more of a persistence schema that understands layout of diagrams, a persistence mechanism to manage the layout data with respect to the authored configuration condition, or persistence of changes to the layout with respect to the configuration condition. In some cases, when the system has received changes to an existing diagram, the changes are persisted independently from the original diagram rather than storing a new copy of the entire diagram. When the modified diagram is used, the relevant portions of the original diagram are modified with the persisted changes on load.

Various embodiments can solve for a layout for a given configuration condition. In such cases, the system can receive, as input, a diagram and the configuration condition and return the set of business objects and the layout data that match the input configuration condition.

Various embodiments can also include the ability to view different configurations of the diagram (different maturity of the business objects), not just the one used to originally author the diagram or the modified diagrams. That is, in some embodiments, when the user views a configured diagram, the system can display a different maturity level of any of the business objects than the state of the object that was used to author the layout, so that the user can analyze the model represented in the diagram without creating multiple copies of the diagram to correspond to the different maturity levels. For example, as described below, a diagram can include multiple revisions of business objects, including multiple maturity levels of the business objects, and the data processing system processes the business objects by selecting specific revisions of the business objects as specified by the application.

Various embodiments can load a portion or the whole diagram, including business objects and layout data, based on user criteria. For example, the system can load just a quadrant of the diagram that is of current interest to the end user or represents the current point of interest for the user.

Disclosed embodiments can also support loading configured diagrams into other applications.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments can determine the layout information for a diagram based on a configuration condition and return that data to the application for viewing/editing for the end user. This process is, in various embodiments, independent of the authoring/viewing application, so that consistent layouts can be displayed from different applications.

Further, disclosed embodiments can de-couple configuration management of business objects and layout from a persistence perspective. The binding of the layout to the business objects can be determined at run time based on the user desired configuration condition.

Various embodiments enable a user to author an initial diagram that will layout out the desired business objects and their connectivity relationships. The user can save the business objects and the layout to the framework, and then release the initial diagram so that the system will lock the business objects and the layout from further modifications.

Disclosed embodiments enable users to view the diagram within the authored configuration condition and get authorization to make changes based on change order. Such a change order can represents a configuration condition that is within the scope of the one that is used to author the diagram initially.

The system can interactively load the same diagram to be modified, including making changes to business objects and layout against a change order. The system can release the change order to release the modified business objects and the modified layout.

The system can load the diagram with its configuration condition set to the original configuration condition. Doing so loads the data against the original configuration condition. The system can also or alternatively load the diagram with the configuration condition coming from the change order; doing so loads the data against the configuration condition specified against the change order.

Disclosed embodiments can also perform a “what if” analysis where the user can analyze the layout based on a configuration condition with a set of business objects that have a different maturity than the ones that were used to author the 2D layout. In performing such an analysis, the system can assist the user where some business objects might be removed or added according to the user's selected conditions.

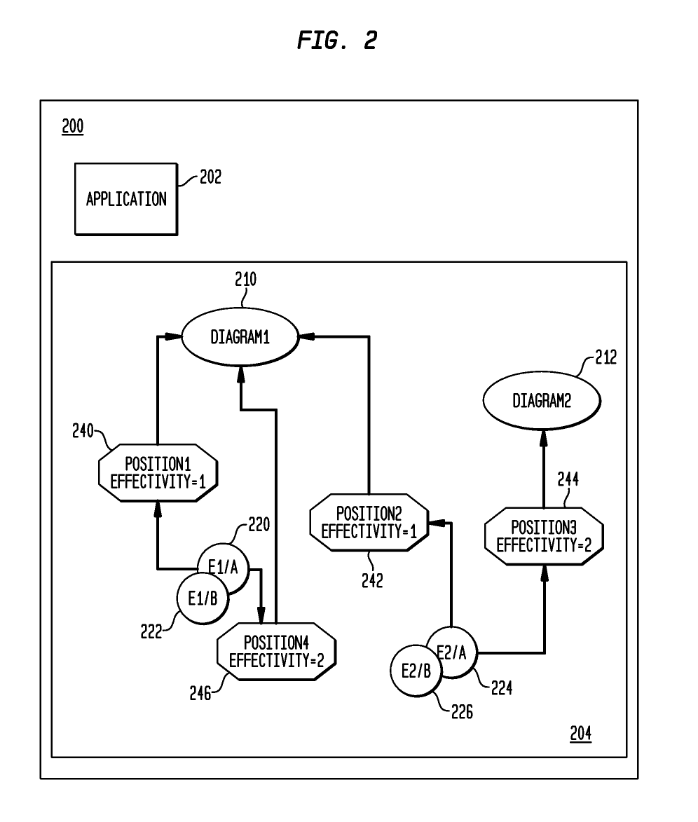

FIG. 2 illustrates elements of a system as disclosed herein, as are stored and managed by a data processing system 200, which can be implemented, for example as a data processing system 100 described above. Data processing system 200 executes application 202 and maintains a storage 204, such as memory 108 or storage 126.

Business objects are represented by circles, such as element 1/A 220, element 1/B 222, element 2/A 224, and element 2/B 226. In this example, the “A” and “B” represent configurable revisions of a business object 220/222/224/226 at different maturity levels; that is, the configuration condition can determine whether element 1/A 220 or element 1/B 222 should be displayed in a configured diagram. The business objects can be edited either independent of the diagram or via modifying the diagram itself.

Diagrams are represented by ovals, such as Diagram1 210 and Diagram2 212.

Layout data with a configuration expression (effectivity or variability) are represented by octagons, such as position1 240, position2 242, position3 244, and position4 246. According to various embodiments, business objects are stored and managed separately from the layout data 240/242/244/246. The layout data can define the symbol (representing the business object) position, arrangement, or display and the configuration expression, which can be explicitly managed by the system. The layout data can be used by applications working with the system. Each business object can be associated with one or more layout data. The various arrows connecting the shapes in this figure indicate such relationships. In this example, note that element 2, represented by element 2/A 224 and element 2/B 226, are associated with both position2 242 and position3 244. This illustrates that the same element2 224 can have different positions in a diagram based on the chosen configuration expression. Layout data can be maintained, modified, and stored separately or independently from the business objects.

The system can configure the business objects with respect to desired configuration conditions and also configure the layout data with respect to the same configuration conditions. The system then combines the results into the appropriate layout data, and returns the layout sheet to the application 202.

The application 202 can process all or only a portion of the data on the appropriate diagram 210, 212 to produce the layout with the data desired by the user, and display only those portions. In this way, the system is not required to receive the entire diagram.

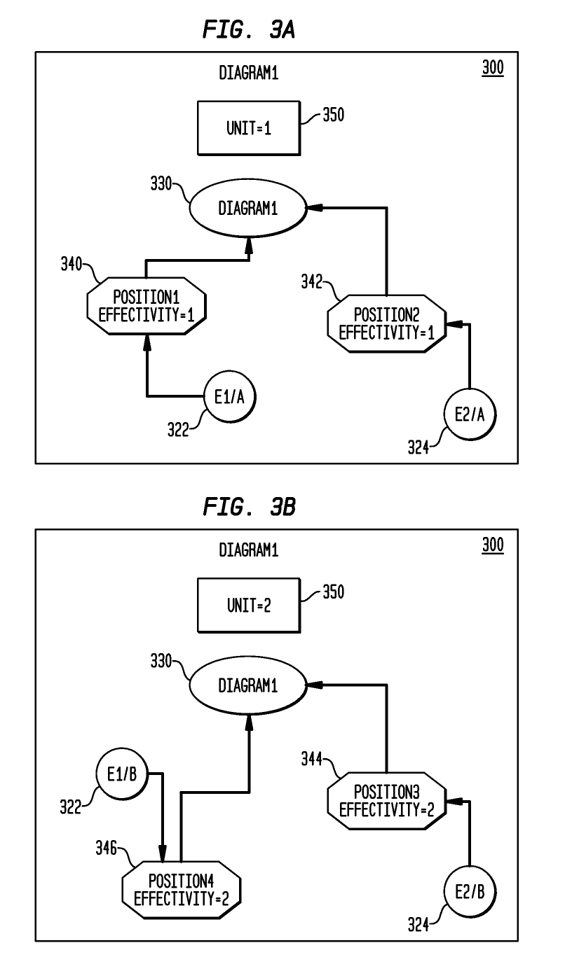

FIGS. 3A and 3B illustrate a data processing system 300 processing business objects and layout data according to configuration conditions to produce a configured diagram.

FIG. 3A illustrates a case where the configuration conditions 350 indicate diagram Diagram1 330 should be configured with the configuration “1”.

The system processes the business objects of FIG. 2 to determine whether element 1/A 220 or element 1/B 222 should be configured (the result indicated here as business object El/A 322), and whether business object 2/A 224, and business object 2/B 226 should be configured (the result indicated here as business object E2/A 324).

The system also processes layout data with respect to configuration conditions 350. Applying Unit Number “1” configuration against the layout data, the system determines that layout data 340 and 342 have an effectivity of “1.” From this the system populates diagram1 330 with business object E1/A 322, at location “Position1” according to layout data 340, and business object E2/A 324, at location “Position2” according to layout data 342.

FIG. 3B illustrates a case where the configuration conditions 350 indicate that Diagram1 330 should be used with the configuration “2”.

The system processes the business objects of FIG. 2 to determine whether business object 1/A 220 or business object 1/B 222 should be used (the result indicated here as business object E1/B 322), and whether business object 2/A 224, and business object 2/B 226 should be used (the result indicated here as element E2/B 324).

The system also processes the layout data with respect to configuration conditions 350. Applying Unit Number “2” configuration against the layout data, the system determines that layout data 344 and 346 have an effectivity of “2.” From this the system populates Diagram1 330 with business object E1/B 322, at location “Position4” according to layout data 346, and business object E2/B 324, at location “Position3” according to layout data 344.

The system then displays the resulting diagram 300.

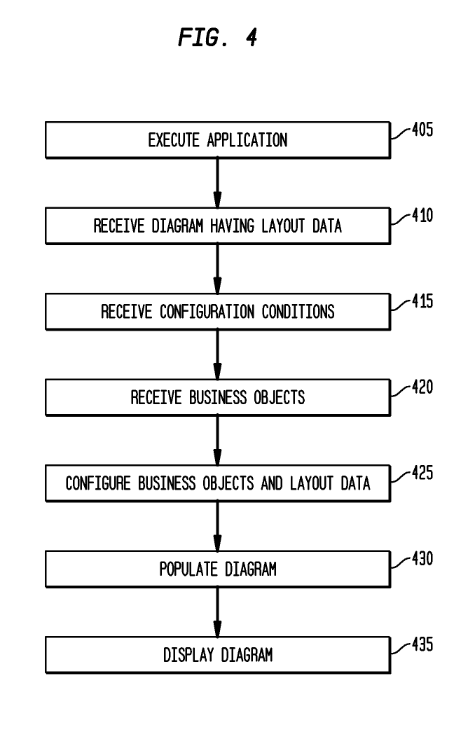

FIG. 4 depicts a flowchart of a process in accordance with disclosed embodiments that may be performed, for example, by a PLM or PDM system as described herein, referred to generically as the “system” below.

The system executes an application (405). One non-limiting example of such an application is the Teamcenter software product by Siemens Product Lifecycle Management Software Inc. (Plano, Tex.).

The system receives at least one diagram having layout data (410). “Receiving,” as used herein, can include loading from storage, receiving from another device or process, receiving via an interaction with a user, or otherwise. The diagram, in specific embodiments, is a product lifecycle diagram that illustrates one or more products, parts, or assemblies.

In particular cases, receiving a diagram can include creating a new diagram via an interaction with a user. In one example of creating a new diagram, the system can allow the user to open a standard library and drag and drop relevant objects into a new diagram. Examples of such objects might represent equipment, valves, and other objects in a domain such as a P&ID (piping and instrumentation diagram). The system can receive user-specified connections between these objects, and can route the connections as specified by the user. The system can also receive the user's selection of graphic attributes of these symbols and connections.

The system can save layout data with the new diagram. The layout data can include the configuration that the sheet is being authored against, including, for example, revision maturity and effectivity. The overall system will also include the business objects that are created with respect to the diagram and the configuration conditions on the business objects.

In various embodiments, the user can find the diagram in the database, can see the diagram stored in an overall container, and can reload the diagram and the layout looking exactly as last persisted.

As the diagram is received, in various embodiments, the system can establish the reference between the diagram and the container, remember the symbols laid out on the diagram, persist the layout against a 2D schema in the database, persist the graphic attributes of the symbols and the connectivity, and persist the configuration conditions used to author the business objects.

Receiving the diagram includes receiving some or all of the data stored with it, as described above. In various embodiments, only relevant portions of the diagram are received, and that portion can be processed as the diagram as described herein, as a portion of the larger, entire diagram.

The system receives configuration conditions (415). In particular, these can be received from the application. The configuration conditions can specify the diagram and can specify the configuration to be applied.

The system receives a plurality of business objects (420). These can include multiple revisions of the business objects. In some cases, this can include receiving, from a user, a selection of a point in or area of the diagram and automatically loading the business objects that correspond in location to the selected point or area of the diagram, and not necessarily loading business objects that do not correspond in location to the selected point or area of the diagram.

The system can process the business objects (425). This can include selecting specific revisions of the business objects as may be specified by the application.

The system populates the diagrams according to the layout data, the configuration conditions, and the business objects (430). This can include evaluating each of the business objects against the configuration conditions and, according to the evaluation, selectively placing the business objects in the diagrams at positions indicated by the configuration conditions.

The system displays the diagram (435). This can include returning the diagram to the application so that the application displays the diagram.

The system can also modify a diagram against a change order via interaction with a user. In one example, assume that the user has a focused location in the sheet that should be modified. Rather than loading the whole sheet, the system can load a portion of the diagram.

In this example, assume that the change order identifies existing equipment that needs to be replaced. The user can perform a “where used” lookup on the existing equipment that identifies the diagram that needs to be modified. The user can specify that he would like to load this sheet with the intention of loading the data around the equipment based on the following input: load all business objects attached to this equipment, and get all data within a certain distance from the equipment. The system identifies and loads the corresponding business objects.

Once the portion of the data has been loaded into the diagram as the business objects, the system can display the information. The system can receive the user's changes to the equipment, such as new equipment from the library or a modified layout. When the user is finished, the system can save the modified diagram.

The type of information that can be saved against the sheet can include the change of the equipment as per the change order, changes to the effectivity on the replaced equipment based on the effectivity of the change order, and delta changes on the layout data that is changed.

In such a case, the system can perform several processes for the user. The system can solve the diagram for the configuration conditions for both the business objects and the layout data based on the connectivity model and a 2D bounding box as described by the user. The system can display the portion of the diagram with the equipment as the focal point of the user. The system can ensure that even though the user is only looking at a portion of the data in the diagram; in this case the delta layout of the sheet is still with respect to the local coordinate system of the sheet. The system can persist the modified layout against a 2D schema in the database, can persist the modified layout with respect to the configuration condition on the change order, and can persist only the delta changes for the modified layout.

According to such a change process, the system may return only a portion of the data as requested by the user and, when the user loads the whole sheet, there is no loss of information based on the whole scope of the diagram.

Disclosed embodiments include a 2D layout schema that can support configuration management, persistence services for saving layouts with configuration conditions, and persistence services for saving a modified layout with changes based configuration conditions. In some cases, the changes can be stored as a delta change that represents what was modified from the original 2D layout.

Disclosed embodiments can process layout data with configuration conditions to produce a configured 2D layout, and can process the 2D layout data with configuration conditions with respect to a partial scope of the diagram or the entire diagram. A partial solution can be based on a subset of the diagram that the user desires to be displayed.

Disclosed embodiments can process the layout data as is also processes the business objects for display.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method for product data management, the method performed by a data processing system and comprising:
executing an application;
receiving a two-dimensional diagram having layout data;
receiving configuration conditions;
receiving a plurality of business objects, each business object associated with the layout data;
populating the diagram according to the layout data, the configuration conditions, and the business objects; and
displaying the diagram.

2. The method of claim 1, wherein the plurality of business objects includes multiple revisions of business objects, and the data processing system processes the business objects by selecting specific revisions of the business objects as specified by the application.

3. The method of claim 1, wherein the configuration conditions specify the diagram and a configuration to be applied, and wherein the layout data is stored and maintained independently of the business objects.

4. The method of claim 1, wherein the data processing system evaluates each of the business objects against the configuration conditions and, according to the evaluation, selectively places the business objects in the diagram at positions indicated by the configuration conditions.

5. The method of claim 1, wherein the data processing system returns the diagram to the application and the application displays the diagram.

6. The method of claim 1, wherein the diagram is a portion of a larger diagram, and receiving the plurality of business objects includes receiving, from a user, a selection of a point in or area of the diagram and automatically loading business objects that correspond in location to the selected point or area of the diagram.

7. The method of claim 1, wherein the layout data includes the diagram to which the layout data belongs, a configuration that the diagram is being authored against, revision rules, and effectivity.

8. A data processing system comprising:
a processor; and
an accessible memory, the data processing system particularly configured to execute an application;
receive a diagram having layout data;
receive configuration conditions;
receive a plurality of business objects, each business object associated with the layout data;
populate the diagram according to the layout data, the configuration conditions, and the business objects; and
display the configured diagram.

9. The data processing system of claim 8, wherein the plurality of business objects includes multiple revisions of business objects, and the data processing system processes the business objects by selecting specific revisions of the business objects as specified by the application.

10. The data processing system of claim 8, wherein the configuration conditions specify the diagram and a configuration to be applied, and wherein the layout data is stored and maintained independently of the business objects.

11. The data processing system of claim 8, wherein the data processing system evaluates each of the business objects against the configuration conditions and, according to the evaluation, selectively places the business objects in the diagram at positions indicated by the configuration conditions.

12. The data processing system of claim 8, wherein the data processing system returns the diagram to the application and the application displays the configured diagram.

13. The data processing system of claim 8, wherein the diagram is a portion of a larger diagram, and receiving the plurality of business objects includes receiving, from a user, a selection of a point in or area of the diagram and automatically loading business objects that correspond in location to the selected point or area of the diagram.

14. The data processing system of claim 8, wherein the layout data includes the diagram to which the layout data belongs, a configuration that the sheet is being authored against, revision rules, and effectivity.

15. A non-transitory computer-readable medium encoded with executable instructions that, when executed, cause one or more data processing systems to:
execute an application;
receive a diagram having layout data;
receive configuration conditions;
receive a plurality of business objects, each business object associated with the layout data;
populate the diagram according to the layout data, the configuration conditions, and the business objects; and
display the diagram.

16. The computer-readable medium of claim 15, wherein the plurality of business objects includes multiple revisions of business objects, and the data processing system processes the business objects by selecting specific revisions of the business objects as specified by the application.

17. The computer-readable medium of claim 15, wherein the configuration conditions specify the diagram and a configuration to be applied, and wherein the layout data is stored and maintained independently of the business objects.

18. The computer-readable medium of claim 15, wherein the data processing system evaluates each of the business objects against the configuration conditions and, according to the evaluation, selectively places the business objects in the diagram at positions indicated by the configuration conditions.

19. The computer-readable medium of claim 15, wherein the data processing system returns the diagram to the application and the application displays the configured diagram.

20. The computer-readable medium of claim 15, wherein the layout data includes the diagram to which the layout data belongs, a configuration that the diagram is being authored against, revision rules, and effectivity.
